(19) United States
(12) Patent Application Publication
(10) Pub. No.: US 2024/0150908 A1
(43) Pub. Date: May 9, 2024

(54) ELECTROCHEMICAL CELL FOR FORMING OXYGEN OR HYDROGEN GAS

(71) Applicant: Verdagy, Inc., Moss Landing, CA (US)

(72) Inventor: John C. Goeltz, Marina, CA (US)

(21) Appl. No.: 18/503,404

(22) Filed: Nov. 7, 2023

Related U.S. Application Data
(60) Provisional application No. 63/382,637, filed on Nov. 7, 2022.

(51) Int. Cl. C25B 9/23; C25B 1/04; C25B 15/08

(52) U.S. Cl. CPC C25B 9/23; C25B 1/04; C25B 15/087

(57) ABSTRACT

A method of forming oxygen or hydrogen gas from water includes flowing an anolyte from outside an electrochemical cell to contact an anode of the electrochemical cell, wherein the method is free of flowing a catholyte from outside of the electrochemical cell to contact a cathode of the electrochemical cell, and wherein the cathode forms hydrogen gas. Alternatively, the method includes flowing a catholyte from outside the electrochemical cell to contact the cathode of the electrochemical cell, wherein the method is free of flowing an anolyte from outside of the electrochemical cell to contact the anode of the electrochemical cell, and wherein the anode forms oxygen gas. The electrochemical cell includes the anode, the cathode, and an ion exchange membrane between the anode and the cathode.

### CROSS-REFERENCE TO RELATED APPLICATION

This application claims the benefit of priority to U.S. Provisional Patent Application Ser. No. 63/382,637 filed Nov. 7, 2022, the disclosure of which is incorporated herein in its entirety by reference.

### BACKGROUND

Water electrolyzers typically include two fluid loops: one for the anode, and one for the cathode. This is true irrespective of other advances in design such as redox mediators for one or both gas-producing reactions, pH differentials, and the like. For devices with multiple fluids, such as those including a redox mediator, two completely separate fluid loops, pumps, sensors, and the like, must be maintained. For electrolyzers with a single fluid, e.g., a potassium hydroxide solution for alkaline electrolysis, the balance of plant still requires multiple fluid lines, sensors, and pumps.

### SUMMARY OF THE INVENTION

Various aspects of the present invention provide a method of forming oxygen or hydrogen gas from water. The method includes (1) flowing an anolyte from outside an electrochemical cell to contact an anode of the electrochemical cell, wherein the method is free of flowing a catholyte from outside of the electrochemical cell to contact a cathode of the electrochemical cell, and wherein the cathode forms hydrogen gas, or (2) flowing a catholyte from outside the electrochemical cell to contact the cathode of the electrochemical cell, wherein the method is free of flowing an anolyte from outside of the electrochemical cell to contact the anode of the electrochemical cell, and wherein the anode forms oxygen gas. The electrochemical cell includes the anode, the cathode, and an ion exchange membrane between the anode and the cathode.

Various aspects of the present invention provide a method of operating an electrochemical cell. The method includes (1) flowing an anolyte from outside an electrochemical cell to contact an anode of the electrochemical cell, wherein the method is free of flowing a catholyte from outside of the electrochemical cell to contact a cathode of the electrochemical cell, wherein the cathode forms hydrogen gas, or (2) flowing a catholyte from outside the electrochemical cell to contact the cathode of the electrochemical cell, wherein the method is free of flowing an anolyte from outside of the electrochemical cell to contact the anode of the electrochemical cell, wherein the anode forms oxygen gas. The method includes flowing the anolyte or catholyte flowed from outside the electrochemical cell to contact the anode or cathode of the electrochemical cell out of the electrochemical cell and into a regenerator, wherein the anolyte or catholyte flowed from outside the electrochemical cell to contact the anode or cathode of the electrochemical cell includes a redox mediator. The method also includes oxidizing or reducing the redox mediator in the anolyte or catholyte flowed into the regenerator to form O₂ or H₂ and to form an oxidized or reduced redox mediator, and flowing the anolyte or catholyte including the oxidized or reduced redox mediator back into contact with the anode or cathode. The electrochemical cell includes the anode, the cathode, and an ion exchange membrane between the anode and the cathode.

Various aspects of the present invention provide a method of operating an electrochemical cell. The method includes flowing an anolyte including a reduced redox mediator from outside an electrochemical cell to contact an anode of the electrochemical cell. The method is free of flowing a catholyte from outside of the electrochemical cell to contact a cathode of the electrochemical cell. The contacting of the anode with the anolyte oxidizes the reduces redox mediator to form an oxidized redox mediator. The cathode forms hydrogen gas. The method includes flowing the anolyte flowed from outside the electrochemical cell to contact the anode of the electrochemical cell out of the electrochemical cell and into a regenerator. The method also includes reducing the oxidized redox mediator in the anolyte flowed into the regenerator to form O₂ and to form a reduced redox mediator, and flowing the anolyte including the reduced redox mediator into contact with the anode. The electrochemical cell includes the anode, the cathode, and a cation exchange membrane between the anode and the cathode.

Various aspects of the present invention provide a method of operating an electrochemical cell. The method includes flowing an anolyte including a reduced redox mediator from outside an electrochemical cell to contact an anode of the electrochemical cell. The method is free of flowing a catholyte from outside of the electrochemical cell to contact a cathode of the electrochemical cell. The contacting of the anode with the anolyte oxidizes the reduced redox mediator to form an oxidized redox mediator. The cathode forms hydrogen gas. The method includes flowing the anolyte flowed from outside the electrochemical cell to contact the anode of the electrochemical cell out of the electrochemical cell and into a regenerator. The method also includes reducing the oxidized redox mediator in the anolyte flowed into the regenerator to form O₂ and to form a reduced redox mediator, and flowing the anolyte including the reduced redox mediator into contact with the anode. The electrochemical cell includes the anode, the cathode, and an anion exchange membrane between the anode and the cathode.

Various aspects of the present invention provide a method of operating an electrochemical cell. The method includes flowing a catholyte including an oxidized redox mediator from outside the electrochemical cell to contact the cathode of the electrochemical cell. The method is free of flowing an anolyte from outside of the electrochemical cell to contact the anode of the electrochemical cell. The contacting of the cathode with the catholyte reduces the oxidized redox mediator to form a reduced redox mediator. The anode forms oxygen gas. The method includes flowing the catholyte flowed from outside the electrochemical cell to contact the cathode of the electrochemical cell out of the electrochemical cell and into a regenerator. The method also includes oxidizing the reduced redox mediator in the catholyte flowed into the regenerator to form H₂ and to form the oxidized redox mediator, and flowing the catholyte including the oxidized redox mediator into contact with the cathode. The electrochemical cell includes the anode, the cathode, and an anion exchange membrane between the anode and the cathode.

Various aspects of the present invention provide a method of operating an electrochemical cell. The method includes flowing a catholyte including an oxidized redox mediator from outside the electrochemical cell to contact the cathode of the electrochemical cell. The method is free of flowing an anolyte from outside of the electrochemical cell to contact the anode of the electrochemical cell. The contacting of the cathode with the catholyte reduces the oxidized redox mediator to form a reduced redox mediator. The anode forms oxygen gas. The method includes flowing the catholyte flowed from outside the electrochemical cell to contact the cathode of the electrochemical cell out of the electrochemical cell and into a regenerator. The method also includes oxidizing the reduced redox mediator in the catholyte flowed into the regenerator to form H₂ and to form the oxidized redox mediator, and flowing the catholyte including the oxidized redox mediator back into contact with the cathode. The electrochemical cell includes the anode, the cathode, and a cation exchange membrane between the anode and the cathode.

Various aspects of the present invention provide an electrochemical cell for forming oxygen or hydrogen gas from water. The electrochemical cell includes an anode, a cathode, and an ion exchange membrane between the anode and the cathode. (1) The electrochemical cell includes an anolyte that flows from outside the electrochemical cell to contact the anode of the electrochemical cell, wherein the cathode is free of a catholyte flowed from outside of the electrochemical cell to contact the cathode, and wherein the cathode forms hydrogen gas; or, alternatively, (2) the electrochemical cell includes a catholyte that flows from outside the electrochemical cell to contact the cathode of the electrochemical cell, wherein the anode is free of an anolyte flowed from outside of the electrochemical cell to contact the anode, and wherein the anode forms oxygen gas.

Various aspects of the present invention provide a system for forming oxygen or hydrogen gas from water. The system includes an electrochemical cell that includes an anode, a cathode, and an ion exchange membrane between the anode and the cathode. (1) The electrochemical cell includes an anolyte including a reduced redox mediator that flows from outside the electrochemical cell to contact the anode of the electrochemical cell, wherein the cathode is free of a catholyte flowed from outside of the electrochemical cell to contact the cathode, and wherein the cathode forms hydrogen gas; or, alternatively, (2) the electrochemical cell includes a catholyte including an oxidized redox mediator that flows from outside the electrochemical cell to contact the cathode of the electrochemical cell, wherein the anode is free of an anolyte flowed from outside of the electrochemical cell to contact the anode, and wherein the anode forms oxygen gas. The system includes a regenerator that accepts from the electrochemical cell the anolyte or catholyte flowed from outside the electrochemical cell to contact the anode or cathode of the electrochemical cell, wherein the regenerator oxidizes or reduces the redox mediator in the anolyte or catholyte flowed into the regenerator to form O₂ or H₂ and to form an oxidized or reduced redox mediator, wherein the regenerator flows the anolyte or catholyte including the oxidized or reduced redox mediator back into contact with the anode or cathode.

Various aspects of the present method, electrochemical cell, and system have certain advantages over other methods of generating oxygen or hydrogen from water. For example, in various aspects of the present invention, avoiding flowing catholyte from outside of the cell to the cathode, or avoiding flowing anolyte from outside of the cell to the anode, results in simplified water balancing, simplified maintenance of a pH differential, reduced operating voltage, or a combination thereof. By simplifying maintenance of a pH differential, various aspects of the present invention avoid or reduce the need for active management of pH differential which can include avoiding use of a cell operating with a bipolar membrane to rebalance pH over time. By using a lower operating voltage, various aspects of the present invention can operate more efficiently than other methods of forming oxygen or hydrogen gas from water.

### BRIEF DESCRIPTION OF THE FIGURES

The drawings illustrate generally, by way of example, but not by way of limitation, various aspects of the present invention.

FIG. 1 illustrates an electrochemical cell and regeneration system including an oxygen mediator with a cation exchange membrane, in accordance with various aspects of the present invention.

FIG. 2 illustrates an electrochemical cell and regeneration system including an oxygen mediator with an anion exchange membrane, in accordance with various aspects.

FIG. 3 illustrates an electrochemical cell and regeneration system including a hydrogen mediator with a cation exchange membrane, in accordance with various aspects.

FIG. 4 illustrates an electrochemical cell and regeneration system including a hydrogen mediator with a cation exchange membrane, in accordance with various aspects.

FIG. 5 illustrates voltage versus current density for a dry cathode electrochemical cell, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “metal oxyanion,” as used herein, refers to a polyatomic anion containing two or more atoms wherein at least one atom is a metal and at least one other atom is oxygen. The term “non-metal oxyanion,” as used herein, refers to a polyatomic anion containing two or more atoms wherein at least one atom is a non-metal and at least one other atom is an oxygen. Various examples of the metal oxyanion or the non-metal oxyanion are provided herein. It is to be understood that the metal oxyanion or the non-metal oxyanion may contain any number of metal or non-metal atoms, respectively, and any number of oxygen atoms depending on the permissible valences.

The terms “metal ion” or “metal” or “metal ion of the metal oxyanion,” as used herein, includes any metal ion capable of being converted from a lower oxidation state to a higher oxidation state. Examples of the metal ion in the corresponding metal oxyanion include, but are not limited to, manganese, iron, chromium, selenium, copper, tin, silver, cobalt, uranium, lead, mercury, vanadium, bismuth, titanium, ruthenium, osmium, europium, zinc, cadmium, gold, nickel, palladium, platinum, rhodium, iridium, technetium, rhenium, molybdenum, tungsten, niobium, tantalum, zirconium, hafnium, and combination thereof. In some examples, the metal ion in the corresponding metal oxyanion includes, but are not limited to, iron, copper, tin, chromium, manganese, selenium, tantalum, or combination thereof. In some examples, the metal ion in the corresponding metal oxyanion is copper. In some examples, the metal ion in the corresponding metal oxyanion is tin. In some examples, the metal ion in the corresponding metal oxyanion is iron. In some examples, the metal ion in the corresponding metal oxyanion is chromium. In some examples, the metal ion in the corresponding metal oxyanion is manganese. In some examples, the metal ion in the corresponding metal oxyanion is selenium. In some examples, the metal ion in the corresponding metal oxyanion is tantalum. In some examples, the metal ion in the corresponding metal oxyanion is platinum.

The terms “non-metal ion” or “non-metal” or “non-metal ion of the non-metal oxyanion,” as used herein, includes any non-metal ion capable of being converted from a lower oxidation state to a higher oxidation state. Examples of the non-metal ion in the corresponding non-metal oxyanion include, but are not limited to, a halogen, carbon, sulfur, nitrogen, and phosphorus. The halogen is selected from chloro, fluoro, bromo, or iodo atoms.

The term “oxidation state,” as used herein when referring to the metal ion in the metal oxyanion, includes the degree of oxidation of the metal ion in the metal oxyanion. In some examples, the oxidation state is the net charge on the metal ion. As used herein, the term “lower oxidation state” refers to the relative oxidation state when compared to the “higher oxidation state,” i.e., with a lower oxidation number when compared to that of the same metal ion when in the higher oxidation state. The “lower oxidation state” may be represented as Metal (L) or M(L) illustrating the lower oxidation state of the metal ion. For example, the lower oxidation state of the metal ion may be 1+, 2+, 3+, 4+, 5+, or 6+. Similarly, as used herein, the term “higher oxidation state” refers to the relative oxidation state when compared to the “lower oxidation state,” i.e., with a higher oxidation number when compared to that of the same metal ion when in the lower oxidation state. The “higher oxidation state” may be represented as Metal or M(H) illustrating the higher oxidation state of the metal ion. For example, the higher oxidation state of the metal ion may be 2+, 3+, 4+, 5+, 6+, or 7+.

The PCT application PCT/US2022/070891, published as WO2022187810 is hereby incorporated herein in its entirety by reference.

Method of Forming Oxygen or Hydrogen Gas from Water.

Various aspects of the present invention provide a method of forming oxygen or hydrogen gas from water. The method can include flowing an anolyte from outside an electrochemical cell to contact an anode of the electrochemical cell, wherein the method is free of flowing a catholyte from outside of the electrochemical cell to contact a cathode of the electrochemical cell, and wherein the cathode forms hydrogen gas. Alternatively, the method can include flowing a catholyte from outside the electrochemical cell to contact the cathode of the electrochemical cell, wherein the method is free of flowing an anolyte from outside of the electrochemical cell to contact the anode of the electrochemical cell, and wherein the anode forms oxygen gas. The electrochemical cell includes the anode, the cathode, and an ion exchange membrane between the anode and the cathode. The ion exchange membrane can be an anion exchange membrane (AEM) or a cation exchange membrane (CEM).

The anode or cathode that is free of having an anolyte or catholyte flowed from outside of the electrochemical cell thereto can include water that has flowed through the ion exchange membrane and/or water generated during formation of O₂ or Hz; for an anode free of having anolyte flowed from outside the cell thereto this water can constitute an anolyte for the “dry” anode, and for a cathode free of having catholyte flowed from outside the cell thereto this water can constitute a catholyte for the “dry” cathode. The water can further include anions or cations that have passed through the membrane, such as hydroxide ions, protons, sodium ions, potassium ions, or a combination thereof. The method can include maintaining a pH differential between the anolyte or catholyte of the “dry” electrode (including the water that has flowed through the ion exchange membrane and/or water generated during formation of O₂ or Hz) and the anolyte or catholyte flowed from outside the electrochemical cell to contact the anode or cathode of the electrochemical cell of 0.5 to 10, or 1 to 6, or less than or equal to 10 and greater than or equal to 0.5 and less than, equal to, or greater than 1, 1.5, 2, 2.5, 3, 3.5, 4, 4.5, 5, 5.5, 6, 6.5, 7, 7.5, 8, 8.5, 9, or 9.5. The method can include flowing the anolyte or catholyte of the “dry” electrode to the anolyte or catholyte that is flowed from outside the electrochemical cell to contact the anode or cathode.

The method can include maintaining any suitable voltage between the anode and the cathode of the electrochemical cell, such as 0.1 V to 10 V, or 1.5 V to 2.5 V, or less than or equal to 10 V and greater than or equal to 0.1 V and less than, equal to, or greater than 0.5 V, 1, 1.2, 1.4, 1.6, 1.8, 2, 2.2, 2.4, 2.6, 2.8, 3, 3.5, 4, 4.5, 5, 5.5, 6, 6.5, 7, 7.5, 8, 8.5, 9, or 9.5 V. The method can include operating the electrochemical cell at any suitable temperature, such as a temperature of 25° C. to 150° C., or a temperature of 50° C. to 100° C., or less than or equal to 150° C. and greater than or equal to 25° C. and less than, equal to, or greater than 30° C., 35, 40, 45, 50, 55, 60, 65, 70, 75, 80, 85, 90, 95, 100, 105, 110, 115, 120, 125, 130, 135, 140, or 145° C. The method can include operating the electrochemical cell at any suitable pressure, such as ambient pressure, or such as a pressure of 14 psi to 500 psi, or 40 psi to 500 psi, or a pressure of less than or equal to 500 psi and greater than or equal to 14 psi and less than, equal to, or greater than 15 psi, 20, 30, 40, 50, 60, 70, 80, 90, 100, 120, 140, 160, 180, 200, 220, 240, 260, 280, 300, 320, 340, 360, 380, 400, 420, 440, 460, or 480 psi.

The anolyte or catholyte flowed from outside the electrochemical cell to contact the anode or cathode of the electrochemical cell can include one or more redox mediators. The redox mediator can offset the production of oxygen or hydrogen from the electrode contacting the electrolyte with the redox mediator by becoming reduced or oxidized. The redox mediator can then be flowed outside the cell and treated to reverse the reduction or oxidation that occurred in the cell (e.g., a reduced redox mediator would be regenerated to an oxidized redox mediator, while an oxidized redox mediator would be regenerated to a reduced redox mediator). During the reversal of the reduction or oxidation, hydrogen or oxygen is produced outside the electrochemical cell. The treated redox mediator can then be returned to the respective electrode. The redox mediator can include an oxygen mediator (e.g., which releases oxygen upon regeneration) or a hydrogen mediator (e.g., which releases hydrogen upon regeneration). The redox mediator can be a mediator for both oxygen and hydrogen. The redox mediator can be a mediator for a different product than oxygen or hydrogen. In various aspects, the anolyte or catholyte flowed from outside the electrochemical cell to contact the anode or cathode is free of redox mediators.

The use of the metal oxyanion or the non-metal oxyanion as a redox metal or non-metal (e.g., going from the lower oxidation state to the higher oxidation state and vice versa), as described herein, can allow the operating voltage of the electrochemical cell to be lower even if the half-cell voltage is above that for the oxygen or hydrogen generation. Typically, oxygen generation at the anode in the same cell where hydrogen gas is being generated at the cathode may require an over-potential at the anode beyond the theoretical minimum in order to generate the molecular oxygen at reasonable current densities; likewise, hydrogen generation at the cathode in the same cell where oxygen gas is being generated at the anode may require an over-potential at the cathode beyond the theoretical minimum in order to generate the hydrogen gas at reasonable current densities. Reducing the required over-potential in the aspects provided herein, related to the oxidation or reduction of the one or more oxyanion compounds at the anode, can lower the operating voltage even if the theoretical voltage is slightly higher.

The reduction of the operating voltage can be the result of a lower half-cell potential than what would be required for oxygen evolution at the anode or for hydrogen evolution at the cathode. Because the Gibbs Free Energy may include minimum external work required to accomplish a given transformation (e.g., conversion of water into hydrogen and oxygen), operation below the thermodynamic minimum voltage may be possible if additional energy is provided into the system either as work or as heat. If the heat is obtained from a source other than resistive losses (these losses may include, but not limited to, the losses within the membrane, conductive resistances, solution resistances, and electrode overpotentials) within the cell, the net effect can be a reduced demand in electric power.

The redox mediator can include a metal oxyanion or a non-metal oxyanion. The metal oxyanion can include manganese, chromium, copper, iron, tin, selenium, tantalum, or a combination thereof. The non-metal oxyanion can include chloro, fluoro, bromo, iodo, carbon, sulfur, nitrogen, phosphorus, or a combination thereof. The redox can have any suitable concentration in the anolyte or catholyte, such as a concentration of 0.1 M to 10 M, or 0.2 M to 1.5 M, or less than or equal to 10 M and greater than or equal to 0.1 M and less than, equal to, or greater than 0.2 M, 0.4, 0.6, 0.8, 1, 1.2, 1.4, 1.6, 1.8, 2, 2.5, 3, 3.5, 4, 4.5, 5, 5.5, 6, 6.5, 7, 7.5, 8, 8.5, 9, or 9.5 M. The redox mediator can have the form of an oxidized redox mediator. In various aspects, the oxidized redox mediator can be chosen from MnO₄⁻, HFeO₂⁻, RuO₄⁻, OsO₅²⁻, SnO₃²⁻, SeO₄²⁻, CuO₂²⁻, CrO₄²⁻, TeO₄²⁻, NO₃⁻, PO₄³⁻, SO₄²⁻, ClO₂⁻, ClO₃⁻, ClO₄⁻, BrO₂⁻, BrO₃⁻, BrO₄⁻, IO₂⁻, IO₃⁻, and IO₄⁻. The redox mediator can have the form of a reduced redox mediator. In various aspects, the reduced redox mediator can be chosen from MnO₄²⁻, FeO₄²⁻, RuO₄²⁻, O₅O₄²⁻, HSnO₂⁻, SeO₃²⁻, Cu₂O, CrO₃³⁻, TeO₃²⁻, NO₂⁻, PO₃³⁻, SO₃²⁻, ClO⁻, ClO₂⁻, ClO₃⁻, BrO⁻, BrO₂⁻, BrO₃⁻, IO⁻, IO₂⁻, and IO₃.

The method can further include flowing the anolyte or catholyte that was flowed from outside the electrochemical cell to contact the anode or cathode out of the electrochemical cell and into a regenerator. The method can include oxidizing or reducing the redox mediator in the anolyte or catholyte flowed into the regenerator to form O₂ or H₂ and to form an oxidized or reduced redox mediator, and flowing the anolyte or catholyte including the oxidized or reduced redox mediator back into contact with the anode or cathode. The regenerator can be a pressure-mediated regenerated, a temperature-mediated regenerator, or a combination thereof. The regenerator can be a thermal treater than heats the redox mediator in the anolyte or catholyte flowed into the regenerator. The regenerator can operate at ambient pressure, or above ambient pressure, or at a pressure of 14 psi to 300 psi, or less than or equal to 300 psi and greater than or equal to 14 psi and less than, equal to, or greater than 15 psi, 20, 25, 30, 35, 40, 45, 50, 60, 70, 80, 90, 100, 120, 140, 160, 180, 200, 220, 240, 260, or 280 psi. The regenerator can operate at any suitable temperature, such as a temperature of 25° C. to 500° C., or 50° C. to 500° C., or a temperature of equal to or less than 500° C. and greater than or equal to 25° C. and less than, equal to, or greater than 30° C., 35, 40, 45, 50, 55, 60, 65, 70, 75, 80, 85, 90, 95, 100, 110, 120, 130, 140, 150, 160, 170, 180, 190, 200, 220, 240, 260, 280, 300, 320, 340, 360, 380, 400, 420, 440, 460, or 480° C. In various aspects, at least a portion of the heat in the regenerator is provided by waste heat, a solar thermal process, a geothermal process, a nuclear process, or a combination thereof. The regenerator can optionally include a heat exchanger that transfers heat from one or more exiting streams of the regenerator to the anolyte or catholyte being flowed into the regenerator.

The method can include flowing the anolyte from outside the electrochemical cell to contact the anode of the electrochemical cell, wherein the method is free of flowing a catholyte from outside of the electrochemical cell to contact the cathode of the electrochemical cell. A pH of the anolyte can be about 10 or more, or 9-20, or 10-20, or less than or equal to 20 and greater than or equal to 9 and less than, equal to, or greater than 10, 11, 12, 13, 14, 15, 16, 17, 18, or 20. The method can include producing H₂ at the cathode. A minimum operating voltage of the electrochemical cell can be lower than a minimum operating voltage of a corresponding electrochemical cell that forms oxygen gas at the anode. The method can be free of producing oxygen gas at the anode, or wherein less than 25% of the Faradaic efficiency of an oxygen evolution reaction at the anode is produced. The anolyte flowed from outside the electrochemical cell to contact the anode of the electrochemical cell can include a reduced redox mediator including a metal oxyanion with a metal ion in a lower oxidation state or a non-metal oxyanion with a non-metal ion in a lower oxidation state. The anode can oxidize the redox mediator to form an oxidized redox mediator including a metal oxyanion with a metal ion in a higher oxidation state or a non-metal oxyanion with a non-metal ion in a higher oxidation state. The method can further include flowing the anolyte including the oxidized redox mediator from the anode to a regeneration unit to reduce the oxidized redox mediator to the reduced redox mediator and to release oxygen gas, and flowing the anolyte including the reduced redox mediator to contact the anode. The method can further include adding water to the anolyte. The regenerator can include hydroxide ions, a pH of 10 or more, a catalyst, or a combination thereof. The catalyst can include a metal oxide, such as manganese oxide, ruthenium oxide, silicon oxide, iron oxide, aluminum oxide, or a combination thereof. The ion exchange membrane can include a cation exchange membrane, wherein cations flow from an anode side of the cation exchange membrane to an anode side of the cation exchange membrane; the method can further include including flowing water and/or hydroxide ions from the cathode to a regenerator. The ion exchange membrane can include an anion exchange membrane, wherein hydroxide ions flow from a cathode side of the anion exchange membrane to an anode side of the anion exchange membrane.

The method can include flowing the catholyte from outside the electrochemical cell to contact the cathode of the electrochemical cell, wherein the method is free of flowing an anolyte from outside of the electrochemical cell to contact the anode of the electrochemical cell. The method can include producing O₂ at the anode. A minimum operating voltage of the electrochemical cell can be lower than a minimum operating voltage of a corresponding electrochemical cell that forms hydrogen gas at the cathode. The method can be free of producing H₂ at the cathode, or wherein less than 25% of the Faradaic efficiency of a hydrogen evolution reaction at the cathode is produced. The catholyte flowed from outside the electrochemical cell to contact the cathode of the electrochemical cell can include an oxidized redox mediator including a metal oxyanion with a metal ion in a higher oxidation state or a non-metal oxyanion with a non-metal ion in a higher oxidation state. The cathode can reduce the redox mediator to form a reduced redox mediator including a metal oxyanion with a metal ion in a lower oxidation state or a non-metal oxyanion with a non-metal ion in a lower oxidation state. The method can further include flowing the catholyte including the reduced redox mediator from the cathode to a regeneration unit to oxidize the reduced redox mediator to the oxidized redox mediator and to release hydrogen gas, and flowing the catholyte including the oxidized redox mediator to contact the cathode. The method can further include adding water to the catholyte. The ion exchange membrane can include a cation exchange membrane, wherein protons flow from an anode side of the cation exchange membrane to a cathode side of the cation exchange membrane. The ion exchange membrane can include an anion exchange membrane, wherein hydroxide ions flow from a cathode side of the anion exchange membrane to an anode side of the anion exchange membrane.

### Electrochemical Cell.

In various aspects the present invention provides an electrochemical cell for forming oxygen or hydrogen gas from water. The electrochemical cell can be an electrochemical cell suitable for performing one or more embodiments of the method described herein for forming oxygen or hydrogen gas from water. For example, the electrochemical cell can include an anode, a cathode, and an ion exchange membrane between the anode and the cathode. The electrochemical cell can include an anolyte that flows from outside the electrochemical cell to contact the anode of the electrochemical cell, wherein the cathode is free of a catholyte flowed from outside of the electrochemical cell to contact the cathode, and wherein the cathode forms hydrogen gas. Alternatively, the electrochemical cell can include a catholyte that flows from outside the electrochemical cell to contact the cathode of the electrochemical cell, wherein the anode is free of an anolyte flowed from outside of the electrochemical cell to contact the anode, and wherein the anode forms oxygen gas.

The electrochemical cells in the methods and systems described herein can be a membrane electrolyzer. The electrochemical cell may be a single cell or may be a stack of cells connected in series or in parallel. The electrochemical cell may be a stack of 5 or 6 or 50 or 100 or more electrolyzers connected in series or in parallel. Each cell comprises an anode, a cathode, and an ion exchange membrane.

In some examples, the electrochemical cell provided herein is a monopolar electrolyzer. In monopolar electrolyzers, the electrodes may be connected in parallel where all anodes and all cathodes are connected in parallel. In such monopolar electrolyzers, the operation takes place at high amperage and low voltage. In some examples, the electrochemical cell described herein is a bipolar electrolyzer. In bipolar electrolyzers, the electrodes may be connected in series where all anodes and all cathodes are connected in series. In such bipolar electrolyzers, the operation takes place at low amperage and high voltage. In some examples, the electrochemical cells described herein are a combination of monopolar and bipolar electrolyzers and may be called hybrid electrolyzers.

In some examples of bipolar electrolyzers, the cells are stacked serially constituting the overall electrolyzer and are electrically connected in two ways. In bipolar electrolyzers, a single plate, called a bipolar plate, can serve as a base plate for both the cathode and anode. The electrolyte solution can be hydraulically connected through common manifolds and collectors internal to the cell stack. The stack may be compressed externally to seal all frames and plates against each other, which are typically referred to as a filter press design. In some examples, the bipolar electrolyzer may also be designed as a series of cells, individually sealed, and electrically connected through back-to-back contact, typically known as a single element design. The single element design may also be connected in parallel in which case it would be a monopolar electrolyzer.

In some examples, the cell size may be denoted by the active area dimensions. In some examples, the active area of the electrochemical cells used herein can range from about 0.5 meters to about 1.5 meters tall and from about 0.4 meters to about 3 meters wide. In some examples, the individual chamber thicknesses can range from about 0.5 mm to about 50 mm.

The electrochemical cells used in the methods and systems provided herein can be made from corrosion resistant materials. Such corrosion resistant materials can include, but are not limited to, polyvinylidene fluoride, viton, polyether ether ketone, fluorinated ethylene propylene, fiber-reinforced plastic, halar, ultem (PEI), perfluoroalkoxy, tefzel, tyvar, fibre-reinforced plastic-coated with Derakane 441-400 resin, graphite, akot, tantalum, hastelloy C2000, titanium, or combinations thereof. In some examples, these materials can be used for making the electrochemical cells and/or its components including, but not limited to, tank materials, piping, heat exchangers, pumps, reactors, cell housings, cell frames, electrodes, instrumentation, valves, and all other balance of plant materials. In some examples, the material used for making the electrochemical cell and its components include, but not limited to, titanium.

In some examples, the anode may contain a corrosion stable, electrically conductive base support, such as, but not limited to, amorphous carbon, such as carbon black, fluorinated carbons available under the trademark SFC™ carbons. Other examples of electrically conductive base materials include, but are not limited to, sub-stoichiometric titanium oxides, such as Magneli phase sub-stoichiometric titanium oxides having the formula TiOₓ wherein x ranges from about 1.67 to about 1.9. Some examples of titanium sub-oxides include, without limitation, titanium oxide Ti₄O₇. The electrically conductive base materials can also include, without limitation, metal titanates such as MₓTi_{y}O_{z} such as MₓTi₄O₇, and the like. Some other examples include, without limitation, iron (in form of alloy e.g., steel), titanium, nickel, and their alloys. In some examples, carbon-based materials provide a mechanical support or as blending materials to enhance electrical conductivity but may not be used as catalyst support to prevent corrosion.

In some examples, the anode is not coated with an electrocatalyst. In some examples, the anode is made of an electro conductive base metal such as titanium coated with or without electrocatalysts. Some examples of electrically conductive base materials include, but are not limited to, sub-stoichiometric titanium oxides, such as Magneli phase sub-stoichiometric titanium oxides having the formula TiOₓ wherein x ranges from about 1.67 to about 1.9. Some examples of titanium sub-oxides include, without limitation, titanium oxide Ti₄O₇. The electrically conductive base materials also include, without limitation, metal titanates such as MₓTi_{y}O_{z} such as MₓTi₄O₇, and the like. Some other examples include, without limitation, iron (in form of alloy, e.g., steel), titanium, nickel, and their alloys.

Examples of electrocatalysts include, but are not limited to, highly dispersed metals or alloys of the platinum group metals, such as platinum, palladium, ruthenium, rhodium, iridium, or their combinations such as platinum-rhodium, platinum-ruthenium, titanium mesh coated with PtIr mixed metal oxide or titanium coated with galvanized platinum; electrocatalytic metal oxides, such as, but not limited to, IrO₂; gold, tantalum, carbon, graphite, organometallic macrocyclic compounds, and other electrocatalysts well known in the art. The electrodes can be coated with electrocatalysts using processes well known in the art.

In some examples, the electrodes described herein can comprise porous homogeneous composite structures as well as heterogeneous, layered type composite structures wherein each layer may have a distinct physical and compositional make-up, e.g., porosity and electroconductive base to prevent flooding, and loss of the three phase interface, and resulting electrode performance.

In some examples, the electrodes can include anodes and cathodes having porous polymeric layers on or adjacent to the anolyte or catholyte solution side of the electrode which may assist in decreasing penetration and electrode fouling. Stable polymeric resins or films may be included in a composite electrode layer adjacent to the anolyte comprising resins formed from non-ionic polymers, such as polystyrene, polyvinyl chloride, polysulfone, and the like, or ionic-type charged polymers like those formed from polystyrenesulfonic acid, sulfonated copolymers of styrene and vinylbenzene, carboxylated polymer derivatives, sulfonated or carboxylated polymers having partially or totally fluorinated hydrocarbon chains and aminated polymers like polyvinylpyridine. Stable microporous polymer films may also be included on the dry side to inhibit electrolyte penetration. In some examples, the gas-diffusion cathode includes such cathodes known in the art that are coated with high surface area coatings of precious metals such as gold and/or silver, precious metal alloys, nickel, and the like.

The ion exchange membrane can be a cationic exchange membrane (CEM) or an anion exchange membrane (AEM). In some examples, the cation exchange membranes in the electrochemical cells disclosed herein can be conventional and are available from, for example, Asahi Kasei of Tokyo, Japan; or from Membrane International of Glen Rock, NJ, or DuPont, in the USA. Examples of CEMs include, but are not limited to, N2030WX (Dupont), F8020/F8080 (Flemion), and F6801 (Aciplex). CEMs that are desirable in the methods and systems herein may have minimal resistance loss, greater than 90% selectivity, and high stability. AEMs in the methods and systems herein can be exposed to concentrated metal or non-metal oxyanion containing anolytes. For example, a quaternary amine-containing polymer may be used as an AEM.

Examples of cationic exchange membranes include, but are not limited to, a cation exchange membrane comprising a perfluorinated polymer containing anionic groups, for example sulphonic and/or carboxylic groups. However, it may be appreciated that in some examples, depending on the need to restrict or allow migration of a specific cation or an anion species between the electrolytes, a cation exchange membrane that is more restrictive and thus allows migration of one species of cation while restricting the migration of another species of cation may be used. Similarly, in some examples, depending on the need to restrict or allow migration of a specific anion species between the electrolytes, an anion exchange membrane that is more restrictive and thus allows migration of one species of anion while restricting the migration of another species of anion may be used. Such restrictive cation exchange membranes or anion exchange membranes are commercially available and can be selected by one ordinarily skilled in the art.

In some examples, the membrane may be selected such that it can function in an acidic and/or alkaline electrolytic solution as appropriate. Other desirable characteristics of the membranes include high ion selectivity, low ionic resistance, high burst strength, and high stability in electrolytic solution in a temperature range of room temperature to 150° C. or higher. In some examples, it is desirable that the ion exchange membrane reduces or minimizes the transport of the metal oxyanion or the non-metal oxyanion from the anolyte to the catholyte.

In some examples, the membrane is stable in the temperature range of from about 0° C. to about 150° C.° C., for example from about 0° C. to about 100° C., such as from about 0° C. to about 90° C., for example from 0° C. to about 80° C., such as from about 0° C. to about 70° C., for example from about 0° C. to about 60° C., such as from about 0° C. to about 50° C., for example from about 0° C. to about 40° C., such as from about 0° C. to about 30° C., or higher may be used. For other examples, it may be useful to utilize an ion-specific ion exchange membrane that allows migration of one type of cation but not another; or migration of one type of anion and not another, to achieve a desired product or products in an electrolyte.

The ohmic resistance of the membrane can affect the voltage drop across the anode and cathode, e.g., as the ohmic resistance of the membrane increase, the voltage across the anode and cathode may increase, and vice versa. Membranes that can be used include, but are not limited to, a membrane with relatively low ohmic resistance and relatively high ionic mobility; and a membrane with relatively high hydration characteristics that increase with temperatures, and thus decreasing the ohmic resistance. By selecting a membrane with lower ohmic resistance known in the art, the voltage drop across the anode and the cathode at a specified temperature can be lowered.

System for Forming Oxygen or Hydrogen Gas from Water.

Various aspects of the present invention provide a system for forming oxygen or hydrogen gas from water. The system can include an electrochemical cell that includes an anode, a cathode, and an ion exchange membrane between the anode and the cathode. The electrochemical cell includes an anolyte including a reduced redox mediator that flows from outside the electrochemical cell to contact the anode of the electrochemical cell, wherein the cathode is free of a catholyte flowed from outside of the electrochemical cell to contact the cathode, and wherein the cathode forms hydrogen gas; or, alternatively, the electrochemical cell includes a catholyte including an oxidized redox mediator that flows from outside the electrochemical cell to contact the cathode of the electrochemical cell, wherein the anode is free of an anolyte flowed from outside of the electrochemical cell to contact the anode, and wherein the anode forms oxygen gas. The system can also include a regenerator that accepts from the electrochemical cell the anolyte or catholyte flowed from outside the electrochemical cell to contact the anode or cathode of the electrochemical cell, wherein the regenerator oxidizes or reduces the redox mediator in the anolyte or catholyte flowed into the regenerator to form O₂ or H₂ and to form an oxidized or reduced redox mediator, wherein the regenerator flows the anolyte or catholyte including the oxidized or reduced redox mediator back into contact with the anode or cathode.

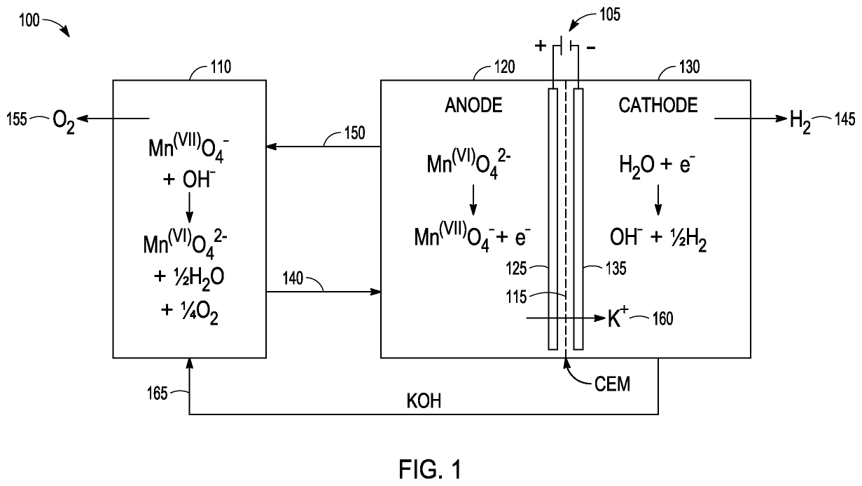

FIG. 1 illustrates a system 100 including an electrochemical cell 105 and a regenerator 110 including an oxygen mediator with a cation exchange membrane 115, in accordance with various aspects of the present invention. The electrochemical cell 105 includes anode compartment 120, anode 125, cathode compartment 130, and cathode 135. A method of operating the electrochemical cell 105 includes flowing an anolyte 140 including a reduced redox mediator from outside the electrochemical cell to contact the anode 125 of the electrochemical cell, wherein the method is free of flowing a catholyte from outside of the electrochemical cell to contact the cathode 135 of the electrochemical cell, wherein the contacting of the anode 125 with the anolyte 140 oxidizes the reduces redox mediator to form an oxidized redox mediator, and wherein the cathode forms hydrogen gas 145. The method includes flowing the anolyte 150 flowed from outside the electrochemical cell to contact the anode of the electrochemical cell out of the electrochemical cell and into the regenerator 110. The method also includes reducing the oxidized redox mediator in the anolyte 150 flowed into the regenerator 110 to form O₂ and to form a reduced redox mediator, and flowing the anolyte 140 including the reduced redox mediator into contact with the anode 125. The anolyte is a solution including manganate, permanganate, and sodium hydroxide. Critically, no catholyte is supplied. When current is passed, manganate is oxidized to permanganate at the anode, water is reduced to hydrogen gas and hydroxide at the cathode, and a cation such as sodium 160 or potassium is passed through a cation exchange membrane from the anode to the cathode. Sufficient water is also passed through the membrane to provide said water for reduction to hydrogen. During the reaction, fluid may be observed collecting in the cathode chamber. This solution of sodium or potassium hydroxide in water 165 can be pumped directly back into the anolyte, simplifying the balance of several molecules and ions of concern: water, sodium/potassium, and hydroxide, obviating the need for more complex balance of plant that may include distillation apparatus, filtration, condensation, and the like. As the electrochemical cell and regeneration system react H₂O to O₂ and H₂ in the overall net reaction, additional water may be fed to the anolyte.

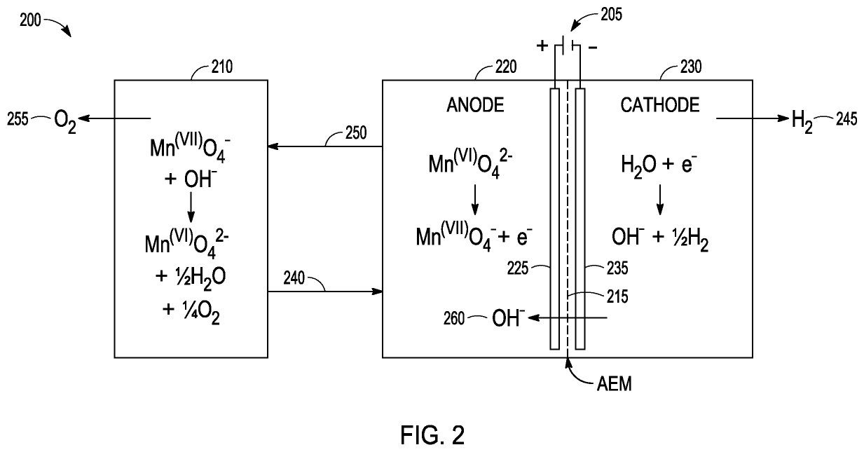

Another aspect uses a mediator for oxygen evolution and an anion exchange membrane. FIG. 2 illustrates a system 200 including an electrochemical cell 205 and a regenerator 210 including an oxygen mediator with an anion exchange membrane 215, in accordance with various aspects of the present invention. The electrochemical cell 205 includes anode compartment 220, anode 225, cathode compartment 230, and cathode 235. A method of operating the electrochemical cell 203 includes flowing an anolyte 240 including a reduced redox mediator from outside the electrochemical cell to contact the anode 225 of the electrochemical cell, wherein the method is free of flowing a catholyte from outside of the electrochemical cell to contact a cathode 235 of the electrochemical cell, wherein the contacting of the anode 225 with the anolyte 240 oxidizes the reduced redox mediator to form an oxidized redox mediator, and wherein the cathode forms hydrogen gas 245. The method includes flowing the anolyte 250 flowed from outside the electrochemical cell to contact the anode of the electrochemical cell out of the electrochemical cell and into the regenerator 210. The method also includes reducing the oxidized redox mediator in the anolyte 250 flowed into the regenerator 210 to form O₂ 255 and to form the reduced redox mediator, and flowing the anolyte 240 including the reduced redox mediator into contact with the anode 225. The anolyte is a solution including manganate, permanganate, and sodium hydroxide. Critically, no catholyte is supplied. Sufficient water from the anolyte is passed through the membrane to provide said water for reduction to hydrogen. When current is passed, manganate is oxidized to permanganate at the anode, water is reduced to hydrogen gas and hydroxide at the cathode, and the hydroxide 260 is passed through an anion exchange membrane from the cathode to the anode. The hydroxide passed to balance charge provides a reactant for oxygen evolution in the regeneration step, resulting in no net change in pH. Such an aspect also benefits from a substantial reduction in balance of plant complexity, potentially reducing or eliminating the need for water and ion rebalancing elements. This aspect may allow operation of cells with a pH differential between the cathode and anode.

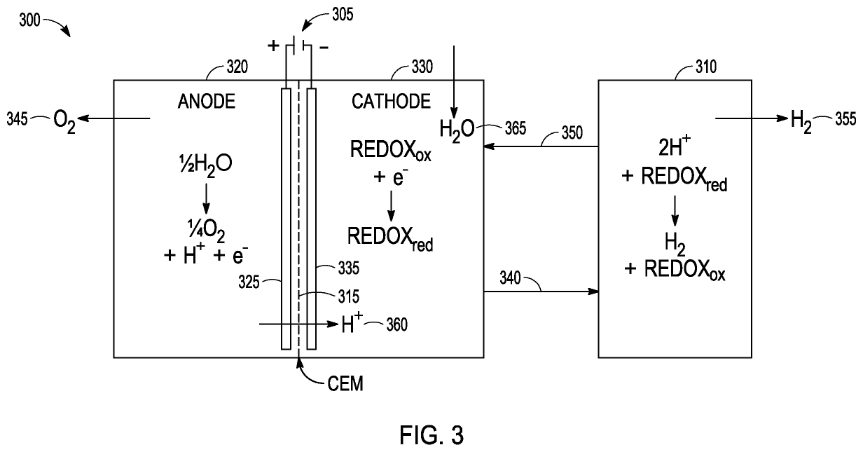

Another aspect uses a mediator for H₂ evolution and a cation exchange membrane. FIG. 3 illustrates a system 300 including an electrochemical cell 305 and a regenerator 310 including a hydrogen mediator with a cation exchange membrane 315, in accordance with various aspects of the present invention. The electrochemical cell 305 includes anode compartment 320, anode 325, cathode compartment 330, and cathode 335. A method of operating the electrochemical cell 305 includes flowing a catholyte 350 including an oxidized redox mediator from outside the electrochemical cell to contact the cathode 335 of the electrochemical cell, wherein the method is free of flowing an anolyte from outside of the electrochemical cell to contact the anode 325 of the electrochemical cell, wherein contacting of the cathode 335 with the catholyte 350 reduces the oxidized redox mediator to form a reduced redox mediator, and wherein the anode 325 forms oxygen gas 345. The method includes flowing the catholyte 340 flowed from outside the electrochemical cell to contact the cathode of the electrochemical cell out of the electrochemical cell and into a regenerator 310. The method includes oxidizing the reduced redox mediator in the catholyte 340 flowed into the regenerator 310 to form H₂ 355 and to form the oxidized redox mediator, and flowing the catholyte 350 including the oxidized redox mediator into contact with the cathode 335. The catholyte includes a redox mediator, while no anolyte is supplied to the anode. Sufficient water is passed from the cathode to the anode, enough to electrolyze into oxygen and protons and to pass the protons back across the membrane to the cathode to balance the charge. When current is passed, oxygen is evolved at the anode, and the redox mediator is reduced at the cathode. The protons 360 passed through the membrane from the anode are used during the regeneration step to produce hydrogen gas with no net change in pH. This aspect may support operation with a pH differential between the anode and cathode.

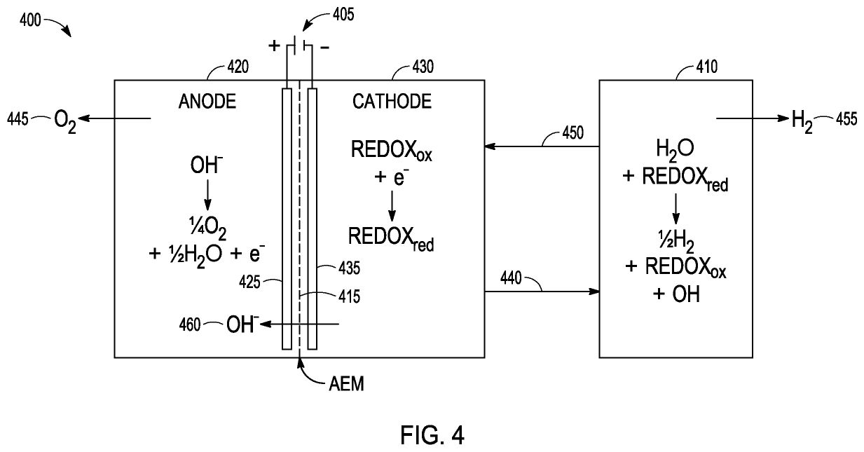

Another aspect uses a mediator for H₂ evolution and an anion exchange membrane. FIG. 4 illustrates a system 400 including an electrochemical cell 405 and regenerator 410 including a hydrogen mediator with a cation exchange membrane 415, in accordance with various aspects of the present invention. The electrochemical cell 405 includes anode compartment 420, anode 425, cathode compartment 430, and cathode 435. A method of operating the electrochemical cell 405 includes flowing a catholyte 450 including an oxidized redox mediator from outside the electrochemical cell to contact the cathode 435 of the electrochemical cell, wherein the method is free of flowing an anolyte from outside of the electrochemical cell to contact the anode of the electrochemical cell, wherein the contacting of the cathode 435 with the catholyte 450 reduces the oxidized redox mediator to form a reduced redox mediator, and wherein the anode forms oxygen gas 445. The method includes flowing the catholyte 450 flowed from outside the electrochemical cell to contact the cathode of the electrochemical cell out of the electrochemical cell and into the regenerator 410. The method also includes oxidizing the reduced redox mediator in the catholyte 440 flowed into the regenerator 410 to form H₂ 455 and to form the oxidized redox mediator, and flowing the catholyte 450 including the oxidized redox mediator back into contact with the cathode 435. The catholyte includes a redox mediator, while no anolyte is supplied to the anode. When current is passed, oxygen is evolved at the anode, and the redox mediator is reduced at the cathode. Hydroxide ions 460 pass from the cathode side of the membrane to the anode side. During the reaction, fluid may be observed collecting in the anode chamber. This water can be pumped directly back into the catholyte, simplifying the materials balance and obviating the need for more complex balance of plant that may include distillation apparatus, filtration, condensation, and the like. As the electrochemical cell and regeneration system react H₂O to O₂ and H₂ in the overall net reaction, additional water may be fed to the catholyte.

### Examples

Various aspects of the present invention can be better understood by reference to the following Examples which are offered by way of illustration. The present invention is not limited to the Examples given herein.

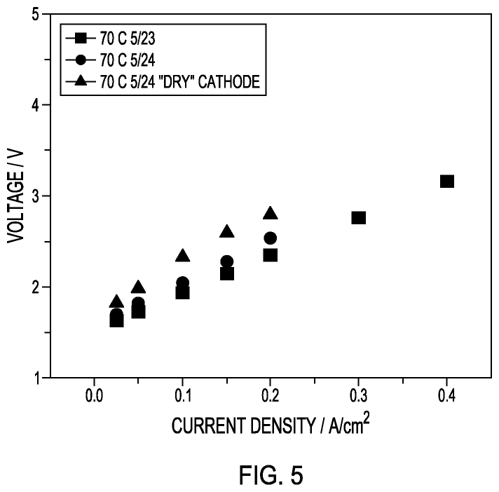

The aspect depicted in FIG. 1 was constructed, having a “dry” cathode (i.e., having no catholyte from outside the electrochemical cell flowed into the cathode compartment to contact the cathode). FIG. 5 illustrates voltage versus current density for the electrochemical cell. The dry cathode arrangement in this Example results in a modest voltage penalty that may in some cases be offset by a simplified balance of plant.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a method of forming oxygen or hydrogen gas from water, the method comprising:

flowing an anolyte from outside an electrochemical cell to contact an anode of the electrochemical cell, wherein the method is free of flowing a catholyte from outside of the electrochemical cell to contact a cathode of the electrochemical cell, and wherein the cathode forms hydrogen gas, or flowing a catholyte from outside the electrochemical cell to contact the cathode of the electrochemical cell, wherein the method is free of flowing an anolyte from outside of the electrochemical cell to contact the anode of the electrochemical cell, and wherein the anode forms oxygen gas;
wherein the electrochemical cell comprises the anode, the cathode, and an ion exchange membrane between the anode and the cathode.

Aspect 2 provides the method of Aspect 1, wherein the membrane is a cation exchange membrane.

Aspect 3 provides the method of Aspect 1, wherein the membrane is an anion exchange membrane.

Aspect 4 provides the method of any one of Aspects 1-3, wherein the anode or cathode that is free of having an anolyte or catholyte flowed from outside of the electrochemical cell thereto comprises water that has flowed through the ion exchange membrane and/or water generated during formation of O₂ or H₂.

Aspect 5 provides the method of Aspect 4, further comprising maintaining a pH differential between the water that has flowed through the ion exchange membrane and/or water generated during formation of O₂ or H₂ and the anolyte or catholyte flowed from outside the electrochemical cell to contact the anode or cathode of the electrochemical cell of 0.5 to 10.

Aspect 6 provides the method of 5, wherein the pH differential is 1 to 6.

Aspect 7 provides the method of any one of Aspects 4-6, further comprising flowing the water that has flowed through the ion exchange membrane and/or water generated during formation of O₂ or H₂ to the anolyte or catholyte that is flowed from outside the electrochemical cell to contact the anode or cathode.

Aspect 8 provides the method of any one of Aspects 1-7, wherein the anode or cathode that is free of having an anolyte or catholyte flowed from outside of the electrochemical cell thereto comprises hydroxide ions, sodium ions, potassium ions, or a combination thereof, that have diffused through the ion exchange membrane.

Aspect 9 provides the method of any one of Aspects 1-8, wherein the method comprises maintaining a voltage between the anode and cathode of 0.1 V to 10 V.

Aspect 10 provides the method of any one of Aspects 1-9, wherein the method comprises maintaining a voltage between the anode and cathode of 1.5 V to 2.5 V.

Aspect 11 provides the method of any one of Aspects 1-10, wherein the method comprises operating the electrochemical cell at a temperature of 50° C. to 100° C.

Aspect 12 provides the method of any one of Aspects 1-11, wherein the method comprises operating the electrochemical cell at ambient pressure.

Aspect 13 provides the method of any one of Aspects 1-12, wherein the method comprises operating the electrochemical cell at a pressure of 40 psi to 500 psi

Aspect 14 provides the method of any one of Aspects 1-13, wherein the anolyte or catholyte flowed from outside the electrochemical cell to contact the anode or cathode of the electrochemical cell comprises a redox mediator.

Aspect 15 provides the method of Aspect 14, wherein the redox mediator is an oxygen mediator.

Aspect 16 provides the method of any one of Aspects 14-15, wherein the redox mediator is a hydrogen mediator.

Aspect 17 provides the method of any one of Aspects 14-16, wherein the redox mediator comprises a metal oxyanion or a non-metal oxyanion.

Aspect 18 provides the method of Aspect 17, wherein the metal oxyanion comprises manganese, chromium, copper, iron, tin, selenium, tantalum, or a combination thereof.

Aspect 19 provides the method of any one of Aspects 17-18, wherein the non-metal oxyanion comprises chloro, fluoro, bromo, iodo, carbon, sulfur, nitrogen, phosphorus, or a combination thereof.

Aspect 20 provides the method of any one of Aspects 14-19, wherein a concentration of the redox mediator in the anolyte or catholyte flowed from outside the electrochemical cell to contact the anode or cathode of the electrochemical cell is 0.1 M to 10 M.

Aspect 21 provides the method of any one of Aspects 14-20, wherein a concentration of the redox mediator in the anolyte or catholyte flowed from outside the electrochemical cell to contact the anode or cathode of the electrochemical cell is 0.2 M to 1.5 M.

Aspect 22 provides the method of any one of Aspects 14-21, wherein the redox mediator has the form of an oxidized redox mediator, wherein the redox mediator is chosen from MnO₄⁻, HFeO₂⁻, RuO₄⁻, OsO₅²⁻, OsO₃²⁻, SeO₄²⁻, CuO₂²⁻, CrO₄²⁻, TeO₄²⁻, NO₃⁻, PO₄³⁻, SO₄²⁻, ClO₂⁻, ClO₃⁻, ClO₄⁻, BrO₂⁻, BrO₃⁻, BrO₄⁻, IO₂⁻, IO₃⁻, and IO₄⁻.

Aspect 23 provides the method of any one of Aspects 14-22, wherein the redox mediator has the form of a reduced redox mediator, wherein the redox mediator is chosen from MnO₄²⁻, FeO₄²⁻, RuO₄²⁻, OsO₄²⁻, HSnO₂⁻, SeO₃²⁻, Cu₂O, CrO₃³⁻, TeO₃²⁻, NO₂⁻, PO₃³⁻, SO₃²⁻, ClO⁻, ClO₂⁻, ClO₃⁻, BrO⁻, BrO₂⁻, BrO₃⁻, IO⁻, IO₂⁻, and IO₃.

Aspect 24 provides the method of any one of Aspects 14-23, further comprising flowing the anolyte or catholyte flowed from outside the electrochemical cell to contact the anode or cathode of the electrochemical cell out of the electrochemical cell and into a regenerator.

Aspect 25 provides the method of Aspect 24, wherein the method comprises oxidizing or reducing the redox mediator in the anolyte or catholyte flowed into the regenerator to form O₂ or H₂ and to form an oxidized or reduced redox mediator, and flowing the anolyte or catholyte comprising the oxidized or reduced redox mediator back into contact with the anode or cathode.

Aspect 26 provides the method of any one of Aspects 24-25, wherein the regenerator is a pressure-mediated regenerator, a temperature-mediated regenerator, or a combination thereof.

Aspect 27 provides the method of any one of Aspects 24-26, wherein the regenerator operates above ambient pressure.

Aspect 28 provides the method of any one of Aspects 24-27, wherein the regenerator operates at a pressure of 14 psi to 300 psi.

Aspect 29 provides the method of any one of Aspects 24-28, wherein the regenerator is a temperature-mediated regenerator.

Aspect 30 provides the method of any one of Aspects 24-29, wherein the regenerator is a thermal treater that heats the redox mediator in the anolyte or catholyte flowed into the regenerator.

Aspect 31 provides the method of Aspect 30, wherein at least a portion of the heat in the regenerator is provided by waste heat, a solar thermal process, a geothermal process, a nuclear process, or a combination thereof.

Aspect 32 provides the method of any one of Aspects 30-31, wherein the regenerator comprises a heat exchanger that transfers heat from one or more exiting streams to the anolyte or catholyte being flowed into the regenerator.

Aspect 33 provides the method of any one of Aspects 24-32, wherein the regenerator heats the redox mediator in the anolyte or catholyte flowed into the regenerator to a temperature of 50° C. to 500° C.

Aspect 34 provides the method of any one of Aspects 1-33, wherein the method comprises flowing the anolyte from outside the electrochemical cell to contact the anode of the electrochemical cell, wherein the method is free of flowing a catholyte from outside of the electrochemical cell to contact the cathode of the electrochemical cell.

Aspect 35 provides the method of Aspect 34, wherein a pH of the anolyte is about 10 or more.

Aspect 36 provides the method of any one of Aspects 34-35, wherein the method comprises producing H₂ at the cathode.

Aspect 37 provides the method of any one of Aspects 34-36, wherein a minimum operating voltage of the electrochemical cell is lower than a minimum operating voltage of a corresponding electrochemical cell that forms oxygen gas at the anode.

Aspect 38 provides the method of any one of Aspects 34-37, wherein the method is free of producing oxygen gas at the anode, or wherein less than 25% of the Faradaic efficiency of an oxygen evolution reaction at the anode is produced.

Aspect 39 provides the method of any one of Aspects 34-38, wherein the anolyte flowed from outside the electrochemical cell to contact the anode of the electrochemical cell comprises a reduced redox mediator comprising a metal oxyanion with a metal ion in a lower oxidation state or a non-metal oxyanion with a non-metal ion in a lower oxidation state, wherein the anode oxidizes the redox mediator to form an oxidized redox mediator comprising a metal oxyanion with a metal ion in a higher oxidation state or a non-metal oxyanion with a non-metal ion in a higher oxidation state.

Aspect 40 provides the method of Aspect 39, wherein the method further comprises flowing the anolyte comprising the oxidized redox mediator from the anode to a regeneration unit to reduce the oxidized redox mediator to the reduced redox mediator and to release oxygen gas, and flowing the anolyte comprising the reduced redox mediator to contact the anode.

Aspect 41 provides the method of Aspect 40, further comprising adding water to the anolyte.

Aspect 42 provides the method of any one of Aspects 40-41, wherein the regenerator comprises hydroxide ions, a pH of 10 or more, a catalyst, or a combination thereof.

Aspect 43 provides the method of Aspect 42, wherein the catalyst comprises a metal oxide, such as manganese oxide, ruthenium oxide, silicon oxide, iron oxide, aluminum oxide, or a combination thereof.

Aspect 44 provides the method of any one of Aspects 34-43, wherein the ion exchange membrane comprises a cation exchange membrane, wherein cations flow from an anode side of the cation exchange membrane to an anode side of the cation exchange membrane.

Aspect 45 provides the method of Aspect 44, further comprising flowing water and or hydroxide ions from the cathode to a regenerator.

Aspect 46 provides the method of any one of Aspects 34-43, wherein the ion exchange membrane comprises an anion exchange membrane, wherein hydroxide ions flow from a cathode side of the anion exchange membrane to an anode side of the anion exchange membrane.

Aspect 47 provides the method of any one of Aspects 1-33, wherein the method comprises flowing the catholyte from outside the electrochemical cell to contact the cathode of the electrochemical cell, wherein the method is free of flowing an anolyte from outside of the electrochemical cell to contact the anode of the electrochemical cell.

Aspect 48 provides the method of Aspect 47, wherein the method comprises producing O₂ at the anode.

Aspect 49 provides the method of any one of Aspects 47-48, wherein a minimum operating voltage of the electrochemical cell is lower than a minimum operating voltage of a corresponding electrochemical cell that forms hydrogen gas at the cathode.

Aspect 50 provides the method of any one of Aspects 47-49, wherein the method is free of producing H₂ at the cathode, or wherein less than 25% of the Faradaic efficiency for a hydrogen evolution reaction at the cathode is produced.

Aspect 51 provides the method of any one of Aspects 47-50, wherein the catholyte flowed from outside the electrochemical cell to contact the cathode of the electrochemical cell comprises an oxidized redox mediator comprising a metal oxyanion with a metal ion in a higher oxidation state or a non-metal oxyanion with a non-metal ion in a higher oxidation state, wherein the cathode reduces the redox mediator to form a reduced redox mediator comprising a metal oxyanion with a metal ion in a lower oxidation state or a non-metal oxyanion with a non-metal ion in a lower oxidation state.

Aspect 52 provides the method of Aspect 51, wherein the method further comprises flowing the catholyte comprising the reduced redox mediator from the cathode to a regeneration unit to oxidize the reduced redox mediator to the oxidized redox mediator and to release hydrogen gas, and flowing the catholyte comprising the oxidized redox mediator to contact the cathode.

Aspect 53 provides the method of Aspect 52, further comprising adding water to the catholyte.

Aspect 54 provides the method of any one of Aspects 47-53, wherein the ion exchange membrane comprises a cation exchange membrane, wherein protons flow from an anode side of the cation exchange membrane to a cathode side of the cation exchange membrane.

Aspect 55 provides the method of any one of Aspects 47-54, wherein the ion exchange membrane comprises an anion exchange membrane, wherein hydroxide ions flow from a cathode side of the anion exchange membrane to an anode side of the anion exchange membrane.

Aspect 56 provides a method of operating an electrochemical cell, the method comprising:
flowing an anolyte from outside an electrochemical cell to contact an anode of the electrochemical cell, wherein the method is free of flowing a catholyte from outside of the electrochemical cell to contact a cathode of the electrochemical cell, wherein the cathode forms hydrogen gas, or
flowing a catholyte from outside the electrochemical cell to contact the cathode of the electrochemical cell, wherein the method is free of flowing an anolyte from outside of the electrochemical cell to contact the anode of the electrochemical cell, wherein the anode forms oxygen gas;
flowing the anolyte or catholyte flowed from outside the electrochemical cell to contact the anode or cathode of the electrochemical cell out of the electrochemical cell and into a regenerator, wherein the anolyte or catholyte flowed from outside the electrochemical cell to contact the anode or cathode of the electrochemical cell comprises a redox mediator; and
oxidizing or reducing the redox mediator in the anolyte or catholyte flowed into the regenerator to form O₂ or H₂ and to form an oxidized or reduced redox mediator, and flowing the anolyte or catholyte comprising the oxidized or reduced redox mediator back into contact with the anode or cathode;
wherein the electrochemical cell comprises the anode, the cathode, and an ion exchange membrane between the anode and the cathode.

Aspect 57 provides a method of operating an electrochemical cell, the method comprising:
flowing an anolyte comprising a reduced redox mediator from outside an electrochemical cell to contact an anode of the electrochemical cell, wherein the method is free of flowing a catholyte from outside of the electrochemical cell to contact a cathode of the electrochemical cell, wherein the contacting of the anode with the anolyte oxidizes the reduces redox mediator to form an oxidized redox mediator, and wherein the cathode forms hydrogen gas;
flowing the anolyte flowed from outside the electrochemical cell to contact the anode of the electrochemical cell out of the electrochemical cell and into a regenerator; and
reducing the oxidized redox mediator in the anolyte flowed into the regenerator to form O₂ and to form a reduced redox mediator, and flowing the anolyte comprising the reduced redox mediator into contact with the anode;
wherein the electrochemical cell comprises the anode, the cathode, and a cation exchange membrane between the anode and the cathode.

Aspect 58 provides a method of operating an electrochemical cell, the method comprising:
flowing an anolyte comprising a reduced redox mediator from outside an electrochemical cell to contact an anode of the electrochemical cell, wherein the method is free of flowing a catholyte from outside of the electrochemical cell to contact a cathode of the electrochemical cell, wherein the contacting of the anode with the anolyte oxidizes the reduced redox mediator to form an oxidized redox mediator, and wherein the cathode forms hydrogen gas;
flowing the anolyte flowed from outside the electrochemical cell to contact the anode of the electrochemical cell out of the electrochemical cell and into a regenerator; and
reducing the oxidized redox mediator in the anolyte flowed into the regenerator to form O₂ and to form a reduced redox mediator, and flowing the anolyte comprising the reduced redox mediator into contact with the anode;
wherein the electrochemical cell comprises the anode, the cathode, and an anion exchange membrane between the anode and the cathode.

Aspect 59 provides a method of operating an electrochemical cell, the method comprising:
flowing a catholyte comprising an oxidized redox mediator from outside the electrochemical cell to contact the cathode of the electrochemical cell, wherein the method is free of flowing an anolyte from outside of the electrochemical cell to contact the anode of the electrochemical cell, wherein contacting of the cathode with the catholyte reduces the oxidized redox mediator to form a reduced redox mediator, and wherein the anode forms oxygen gas;
flowing the catholyte flowed from outside the electrochemical cell to contact the cathode of the electrochemical cell out of the electrochemical cell and into a regenerator; and
oxidizing the reduced redox mediator in the catholyte flowed into the regenerator to form H₂ and to form the oxidized redox mediator, and flowing the catholyte comprising the oxidized redox mediator into contact with the cathode;
wherein the electrochemical cell comprises the anode, the cathode, and an anion exchange membrane between the anode and the cathode.

Aspect 60 provides a method of operating an electrochemical cell, the method comprising:
flowing a catholyte comprising an oxidized redox mediator from outside the electrochemical cell to contact the cathode of the electrochemical cell, wherein the method is free of flowing an anolyte from outside of the electrochemical cell to contact the anode of the electrochemical cell, wherein the contacting of the cathode with the catholyte reduces the oxidized redox mediator to form a reduced redox mediator, and wherein the anode forms oxygen gas;
flowing the catholyte flowed from outside the electrochemical cell to contact the cathode of the electrochemical cell out of the electrochemical cell and into a regenerator; and
oxidizing the reduced redox mediator in the catholyte flowed into the regenerator to form H₂ and to form the oxidized redox mediator, and flowing the catholyte comprising the oxidized redox mediator back into contact with the cathode;
wherein the electrochemical cell comprises the anode, the cathode, and a cation exchange membrane between the anode and the cathode.

Aspect 61 provides an electrochemical cell for forming oxygen or hydrogen gas from water, the electrochemical cell comprising:
an anode,
a cathode, and
an ion exchange membrane between the anode and the cathode;
wherein
   the electrochemical cell comprises an anolyte that flows from outside the electrochemical cell to contact the anode of the electrochemical cell, wherein the cathode is free of a catholyte flowed from outside of the electrochemical cell to contact the cathode, and wherein the cathode forms hydrogen gas, or
   the electrochemical cell comprises a catholyte that flows from outside the electrochemical cell to contact the cathode of the electrochemical cell, wherein the anode is free of an anolyte flowed from outside of the electrochemical cell to contact the anode, and wherein the anode forms oxygen gas.

Aspect 62 provides a system for forming oxygen or hydrogen gas from water, the system comprising:
an electrochemical cell comprising
   an anode,
   a cathode, and
   an ion exchange membrane between the anode and the cathode;
wherein
   the electrochemical cell comprises an anolyte comprising a reduced redox mediator that flows from outside the electrochemical cell to contact the anode of the electrochemical cell, wherein the cathode is free of a catholyte flowed from outside of the
   electrochemical cell to contact the cathode, and wherein the cathode forms hydrogen gas, or the electrochemical cell comprises a catholyte comprising an oxidized redox mediator that flows from outside the electrochemical cell to contact the cathode of the electrochemical cell, wherein the anode is free of an anolyte flowed from outside of the electrochemical cell to contact the anode, and wherein the anode forms oxygen gas;
   a regenerator that accepts from the electrochemical cell the anolyte or catholyte flowed from outside the electrochemical cell to contact the anode or cathode of the electrochemical cell, wherein the regenerator oxidizes or reduces the redox mediator in the anolyte or catholyte flowed into the regenerator to form O₂ or H₂ and to form an oxidized or reduced redox mediator, wherein the regenerator flows the anolyte or catholyte comprising the oxidized or reduced redox mediator back into contact with the anode or cathode.

Aspect 63 provides the method, electrochemical cell, or system of any one or any combination of Aspects 1-62 optionally configured such that all elements or options recited are available to use or select from.

What is claimed is:

1. A method of forming oxygen or hydrogen gas from water, the method comprising:
flowing an anolyte from outside an electrochemical cell to contact an anode of the electrochemical cell, wherein the method is free of flowing a catholyte from outside of the electrochemical cell to contact a cathode of the electrochemical cell, and wherein the cathode forms hydrogen gas, or
flowing a catholyte from outside the electrochemical cell to contact the cathode of the electrochemical cell, wherein the method is free of flowing an anolyte from outside of the electrochemical cell to contact the anode of the electrochemical cell, and wherein the anode forms oxygen gas;
wherein the electrochemical cell comprises the anode, the cathode, and an ion exchange membrane between the anode and the cathode.

2. The method of claim 1, wherein the membrane is a cation exchange membrane or an anion exchange membrane.

3. The method of claim 1, wherein the anode or cathode that is free of having an anolyte or catholyte flowed from outside of the electrochemical cell thereto comprises water that has flowed through the ion exchange membrane and/or water generated during formation of O₂ or H₂.

4. The method of claim 3, further comprising flowing the water that has flowed through the ion exchange membrane and/or water generated during formation of O₂ or H₂ to the anolyte or catholyte that is flowed from outside the electrochemical cell to contact the anode or cathode.

5. The method of claim 1, wherein the anolyte or catholyte flowed from outside the electrochemical cell to contact the anode or cathode of the electrochemical cell comprises a redox mediator.

6. The method of claim 5, wherein the redox mediator is an oxygen mediator or a hydrogen mediator.

7. The method of claim 5, wherein the redox mediator has the form of an oxidized redox mediator, wherein the redox mediator is chosen from MnO₄⁻, HFeO₂⁻, RuO₄⁻, OsO₅²⁻, SnO₃²⁻, SeO₄²⁻, CuO₂²⁻, CrO₄²⁻, TeO₄²⁻, NO₃⁻, PO₄³⁻, SO₄²⁻, ClO₂⁻, ClO₃⁻, ClO₄⁻, BrO₂⁻, BrO₃⁻, BrO₄⁻, IO₂⁻, IO₃⁻, and IO₄⁻.

8. The method of claim 5, wherein the redox mediator has the form of a reduced redox mediator, wherein the redox mediator is chosen from MnO₄²⁻, FeO₄²⁻, RuO₄²⁻, O₅O₄²⁻, HSnO₂⁻, SeO₃²⁻, Cu₂O, CrO₃³⁻, TeO₃²⁻, NO₂⁻, PO₃³⁻, SO₃²⁻, ClO⁻, ClO₂⁻, ClO₃⁻, BrO⁻, BrO₂⁻, BrO₃⁻, IO⁻, IO₂⁻, and IO₃.

9. The method of claim 5, further comprising flowing the anolyte or catholyte flowed from outside the electrochemical cell to contact the anode or cathode of the electrochemical cell out of the electrochemical cell and into a regenerator, wherein the method comprises oxidizing or reducing the redox mediator in the anolyte or catholyte flowed into the regenerator to form O₂ or H₂ and to form an oxidized or reduced redox mediator, and flowing the anolyte or catholyte comprising the oxidized or reduced redox mediator back into contact with the anode or cathode.

10. The method of claim 9, wherein the regenerator heats the redox mediator in the anolyte or catholyte flowed into the regenerator to a temperature of 50° C. to 500° C.

11. The method of claim 1, wherein the method comprises flowing the anolyte from outside the electrochemical cell to contact the anode of the electrochemical cell, wherein the method is free of flowing a catholyte from outside of the electrochemical cell to contact the cathode of the electrochemical cell.

12. The method of claim 11, wherein
the method comprises producing H₂ at the cathode, and
the method is free of producing oxygen gas at the anode, or wherein less than 25% of the Faradaic efficiency of an oxygen evolution reaction at the anode is produced.

13. The method of claim 11, wherein the anolyte flowed from outside the electrochemical cell to contact the anode of the electrochemical cell comprises a reduced redox mediator comprising a metal oxyanion with a metal ion in a lower oxidation state or a non-metal oxyanion with a non-metal ion in a lower oxidation state, wherein the anode oxidizes the redox mediator to form an oxidized redox mediator comprising a metal oxyanion with a metal ion in a higher oxidation state or a non-metal oxyanion with a non-metal ion in a higher oxidation state.

14. The method of claim 13, wherein the method further comprises flowing the anolyte comprising the oxidized redox mediator from the anode to a regeneration unit to reduce the oxidized redox mediator to the reduced redox mediator and to release oxygen gas, and flowing the anolyte comprising the reduced redox mediator to contact the anode.

15. The method of claim 1, wherein the method comprises flowing the catholyte from outside the electrochemical cell to contact the cathode of the electrochemical cell, wherein the method is free of flowing an anolyte from outside of the electrochemical cell to contact the anode of the electrochemical cell.

16. The method of claim 15, wherein
the method comprises producing O₂ at the anode, and
the method is free of producing H₂ at the cathode, or wherein less than 25% of the Faradaic efficiency of a hydrogen evolution reaction at the cathode is produced.

17. The method of claim 15, wherein the catholyte flowed from outside the electrochemical cell to contact the cathode of the electrochemical cell comprises an oxidized redox mediator comprising a metal oxyanion with a metal ion in a higher oxidation state or a non-metal oxyanion with a non-metal ion in a higher oxidation state, wherein the cathode reduces the redox mediator to form a reduced redox mediator comprising a metal oxyanion with a metal ion in a lower oxidation state or a non-metal oxyanion with a non-metal ion in a lower oxidation state.

18. The method of claim 17, wherein the method further comprises flowing the catholyte comprising the reduced redox mediator from the cathode to a regeneration unit to oxidize the reduced redox mediator to the oxidized redox mediator and to release hydrogen gas, and flowing the catholyte comprising the oxidized redox mediator to contact the cathode.

19. A method of operating an electrochemical cell, the method comprising:
flowing an anolyte from outside an electrochemical cell to contact an anode of the electrochemical cell, wherein the method is free of flowing a catholyte from outside of the electrochemical cell to contact a cathode of the electrochemical cell, wherein the cathode forms hydrogen gas, or
flowing a catholyte from outside the electrochemical cell to contact the cathode of the electrochemical cell, wherein the method is free of flowing an anolyte from outside of the electrochemical cell to contact the anode of the electrochemical cell, wherein the anode forms oxygen gas;
flowing the anolyte or catholyte flowed from outside the electrochemical cell to contact the anode or cathode of the electrochemical cell out of the electrochemical cell and into a regenerator, wherein the anolyte or catholyte flowed from outside the electrochemical cell to contact the anode or cathode of the electrochemical cell comprises a redox mediator; and
oxidizing or reducing the redox mediator in the anolyte or catholyte flowed into the regenerator to form O₂ or H₂ and to form an oxidized or reduced redox mediator, and flowing the anolyte or catholyte comprising the oxidized or reduced redox mediator back into contact with the anode or cathode;
wherein the electrochemical cell comprises the anode, the cathode, and an ion exchange membrane between the anode and the cathode.

20. A system for forming oxygen or hydrogen gas from water, the system comprising:
an electrochemical cell comprising
an anode,
a cathode, and
an ion exchange membrane between the anode and the cathode;
wherein
the electrochemical cell comprises an anolyte comprising a reduced redox mediator that flows from outside the electrochemical cell to contact the anode of the electrochemical cell, wherein the cathode is free of a catholyte flowed from outside of the electrochemical cell to contact the cathode, and wherein the cathode forms hydrogen gas, or
the electrochemical cell comprises a catholyte comprising an oxidized redox mediator that flows from outside the electrochemical cell to contact the cathode of the electrochemical cell, wherein the anode is free of an anolyte flowed from outside of the electrochemical cell to contact the anode, and wherein the anode forms oxygen gas;
a regenerator that accepts from the electrochemical cell the anolyte or catholyte flowed from outside the electrochemical cell to contact the anode or cathode of the electrochemical cell, wherein the regenerator oxidizes or reduces the redox mediator in the anolyte or catholyte flowed into the regenerator to form O₂ or H₂ and to form an oxidized or reduced redox mediator, wherein the regenerator flows the anolyte or catholyte comprising the oxidized or reduced redox mediator back into contact with the anode or cathode.
